(19) United States
(12) Patent Application Publication
(10) Pub. No.: US 2026/0044654 A1
(43) Pub. Date: Feb. 12, 2026

(54) METHOD FOR SIMULATING DEEP SHALE GAS FLOW BASED ON DUAL-SITE LANGMUIR ADSORPTION MODEL

(71) Applicant: China University of Petroleum (East China), Qingdao City (CN)

(72) Inventors: Yongfei YANG, Qingdao City (CN); Jun YAO, Qingdao City (CN); Chaoyang ZHAO, Qingdao City (CN); Kai ZHANG, Qingdao City (CN); Hai SUN, Qingdao City (CN); Junjie ZHONG, Qingdao City (CN); Lei ZHANG, Qingdao City (CN); Jiawei LI, Qingdao City (CN); Haoyun LI, Qingdao City (CN); Tonghui LIU, Qingdao City (CN)

(21) Appl. No.: 19/293,600

(22) Filed: Aug. 7, 2025

(30) Foreign Application Priority Data
Aug. 8, 2024 (CN) 202411084092.6

(51) Int. Cl. G06F 30/28; G06F 113/08

(52) U.S. Cl. CPC G06F 30/28; G06F 2113/08

(57) ABSTRACT

A method for simulating deep shale gas flow based on a dual-site Langmuir adsorption model is provided. The method includes: reconstructing a digital core of a deep shale gas reservoir, and extracting a pore network model; analyzing a structural parameter of the pore network model, and establishing calculation models of a free-phase shale gas conductivity and an adsorption-phase shale gas conductivity; establishing a calculation model of a shale gas conductivity for pores and throats in the pore network model, and determining the shale gas conductivity in pores and throats in the pore network model; combining the pore network model with the calculation models of the free-phase shale gas conductivity, the adsorption-phase shale gas conductivity and the shale gas conductivity in pores and throats, establishing a simulation model of a deep shale gas conductivity and simulating a flow law of deep shale gas.

### CROSS-REFERENCE TO RELATED PRESENT DISCLOSURE

This patent application claims the benefit and priority of Chinese Patent Application No. 202411084092.6 filed with the China National Intellectual Property Administration on Aug. 8, 2024, the disclosure of which is incorporated by reference herein in its entirety as part of the application.

### TECHNICAL FIELD

The present disclosure relates to the technical field of oil reservoir simulation, and in particular to a method for simulating deep shale gas flow based on a dual-site Langmuir adsorption model.

### BACKGROUND

A pore network model, as a fluid flow simulation model within a pore scale, simplifies the complex pore space to a great extent, and has obvious advantages of fast calculation compared with a direct simulation method. A pore network extraction method based on a digital core, such as a maximum sphere method and a central axis method, can better reflect the topology and the geometry of rocks and is very precise in predicting the flow law of fluids. Combined with the percolation theory, the pore network model can simulate a multiphase flow process such as drainage and imbibition, and calculate multiphase flow properties.

Shale gas is an important clean energy source, in which the deep shale gas buried more than 3500 meters is non-negligible in the total shale gas reserves. The flow patterns of shale gas in nano-scale pores are classified into viscous flow, slip flow, transient flow and free molecular flow. Adsorption, surface diffusion, Knudsen diffusion, slip and viscous flow are mainly taken into account in organic pores and throats, while Knudsen diffusion, slip and viscous flow are mainly taken into account in inorganic pores and throats.

However, compared with shallow shale gas, the geological characteristics of deep shale gas are more complicated. Moreover, when the pore network model is applied to shale gas microscopic simulation, the characteristics of deep shale gas are not taken into full account, and the influence of various effects on the flow process of deep shale gas has not been taken into comprehensive account. Therefore, it is urgent to propose a new method for simulating deep shale gas flow to achieve precise simulation of gas flow in deep shale gas.

### SUMMARY

The present disclosure aims at solving the shortcomings of the existing technology, and provides a method for simulating deep shale gas flow based on a dual-site Langmuir adsorption model, which takes into full account the influence of the effects of adsorption, slip, Knudsen diffusion, surface diffusion and the like in the process of shale gas flow in a high-temperature and high-pressure environment, and achieves the precise simulation of the deep shale gas flow process by combining the heterogeneous adsorption of the internal structural surface of the deep shale gas reservoir, thus providing a basis for guiding the exploration and the development of deep shale gas.

The present disclosure uses the following technical scheme.

A method for simulating deep shale gas flow based on a dual-site Langmuir adsorption model is provided, which includes following steps:
step 1, reconstructing a digital core and extracting a pore network model based on a core scanning image of a deep shale gas reservoir;
step 2, analyzing a structural parameter of the pore network model, setting a pore structural property, establishing a calculation model of a free-phase shale gas conductivity and a calculation model of an adsorption-phase shale gas conductivity, and determining the free-phase shale gas conductivity and the adsorption-phase shale gas conductivity in the pore network model;
step 3, establishing a calculation model of a shale gas conductivity for pores and throats in the pore network model according to the calculation model of the free-phase shale gas conductivity and the calculation model of the adsorption-phase shale gas conductivity, and determining shale gas conductivity for the pores and throats in the pore network model to obtain shale gas conductivities in organic pores, inorganic pores, organic pores and throats and inorganic pores and throats;
step 4, based on the calculation model of the free-phase shale gas conductivity, the calculation model of the adsorption-phase shale gas conductivity and the calculation model of the shale gas conductivity for the pores and throats in the pore network model, establishing a simulation model of a deep shale gas conductivity in combination with the pore network model, and determining a flow law of deep shale gas under different sensitivity parameter conditions by using the simulation model of the deep shale gas conductivity for simulation.

In an embodiment, in step 1, the core scanning image of the deep shale gas reservoir is obtained, a binary image is obtained by performing binary segmentation on the core scanning image, after a pore phase and a matrix phase in the binary image are identified, the digital core is reconstructed by using a Markov Chain Monte Carlo method according to a binary segmented image, and the pore network model is extracted by using a maximum sphere method.

In an embodiment, the core scanning image is a Computed Tomography (CT) scanning image or a Scanning Electron Microscope (SEM) scanning image of the core.

In an embodiment, in step 2, analyzing structural parameters of the pore network model includes determining a pore radius, a throat radius, a coordination number and a shape factor of the pore network model; assigning water-wet inorganic pores and gas-wet organic pores in the pore network model; where shale gas including free-phase shale gas and adsorption-phase shale gas is provided in the pore network model, and the adsorption-phase shale gas is single-layer adsorption in the pore network model.

In an embodiment, for the free-phase shale gas in the pore network model, when the adsorption-phase shale gas exists, an effective migration space of the free-phase shale gas in the organic pores is reduced to obtain:

$$θ = \frac{\frac{p}{Z}}{{p}_{L} + \frac{p}{Z}} , \qquad ( 1 )$$

$$h = θ {d}_{m} , \qquad ( 2 )$$

$${r}_{eff} = r - {d}_{m} θ , \qquad ( 3 )$$

where θ denotes a gas coverage degree on surface of the pore and throat; P denotes a pressure of the pore and throat in unit of MPa; p_{L} denotes a Langmuir pressure in unit of MPa; Z denotes a gas compressibility factor; h denotes a thickness of an adsorption phase in unit of m; dₘ denotes a collision diameter of gas molecules in unit of m; r_{eff} denotes an effective flow radius of the free-phase shale gas in unit of m; r denotes a cross-sectional radius of the pore and throat in unit of m;
taking into account an influence of high-temperature and high-pressure environment on a critical temperature and a critical pressure of the shale gas in the pore network model, a gas property of the free-phase shale gas in the pore network model changes;
the critical temperature and the critical pressure of the shale gas in the pore network model are calculated as follows:

$${T}_{c} = \frac{8}{27 b R} [ a - 2 {σ}^{3} ε {N}^{2} \frac{σ}{r} ( 2.6275 - 0.6743 \frac{σ}{r} ) ] , \qquad ( 4 )$$

$${P}_{c} = \frac{8}{27 {b}^{2}} [ a - 2 {σ}^{3} ε {N}^{2} \frac{σ}{r} ( 2.6275 - 0.6743 \frac{σ}{r} ) ] , \qquad ( 5 )$$

where T_{c} denotes the critical temperature of the shale gas; P_{c} denotes the critical pressure of the shale gas; R denotes a constant with a value of 8.314; a denotes a van der Waals (vdW) energy parameter in unit of Pa dm⁶/mol²; b denotes a vdW energy parameter in unit of m³/mol; σ denotes a Lennard-Jones size parameter in unit of m; ϵ denotes a Lennard-Jones energy parameter; N denotes an Avogadro's constant;
gas property parameters of the free-phase shale gas are calculated according to the critical temperature and the critical pressure of the shale gas as follow:

$${p}_{p r} = \frac{p}{{p}_{c}} , \qquad ( 4 - 1 )$$

$${T}_{p r} = \frac{T}{{T}_{c}} , \qquad ( 5 - 1 )$$

$$ρ = 1. 4935 \times 1 {0}^{- 3} \times \frac{p M}{Z T} , \qquad ( 6 )$$

$$μ = 1 \times 1 {0}^{- 4} \times {K}^{′} {e}^{X {ρ}^{Y}} , \qquad ( 7 )$$

where Z is a compressibility factor of the deep shale gas:

$$Z = 0.702 {e}^{- 2.5 {T}_{p r}} \times {p}_{p r}^{2} - 5.524 {e}^{- 2.5 {T}_{p r}} \times {p}_{p r} + 0.044 {T}_{p r}^{2} - 0.164 {T}_{p r} + 1.15 , \qquad ( 8 )$$

where pₚᵣ denotes a relative pressure of the free-phase shale gas; Tₚᵣ denotes a relative temperature of the free-phase shale gas; T denotes a temperature of the pore and throat in unit of K; ρ denotes a density of the shale gas in unit of g/cm³; μ denotes a viscosity of the shale gas in unit of Pa·s; M denotes a molecular mass of the shale gas in unit of g/mol; X, Y and K′ are calculation coefficients of shale gas viscosity,

$$X = 3.448 + \frac{986.4}{T} + 0.010 \; 09 M , Y = 2.447 - 0.2 \; 224 X ,$$

$${K}^{′} = \frac{( 9.379 + 0.01607 M ) \times {T}^{1.5}}{( 209.2 + 19.26 M + T )} ;$$

based on a Hagen-Poiseuille equation, an equation for calculating a volume flow rate of the free-phase shale gas is determined as follows:

$$q = f ( {K}_{n} ) \frac{π {r}_{e f f}^{4}}{8 μ} \frac{Δ p}{l} , \qquad ( 9 )$$

$$where$$

$$f ( {K}_{n} ) = ( 1 + α {K}_{n} ) ( 1 + \frac{4 {K}_{n}}{1 - β {K}_{n}} ) , \qquad ( 10 )$$

$$α = \frac{128}{15 {π}^{2}} {tan}^{- 1} [ 4 {K}_{n}^{0.4} ] , \qquad ( 11 )$$

where q denotes the volume flow rate of the free-phase shale gas; f(Kₙ) denotes a term enabling the Poiseuille equation to be applicable to all flow states; Δp denotes a pressure drop in unit of MPa; l denotes a length of a pore or throat in unit of m; α denotes a gas rarefaction coefficient, which is dimensionless; β denotes a slip coefficient, which is dimensionless; Kₙ denotes a Knudsen number;
based on the volume flow rate of the free-phase shale gas and taking into account a slip effect of the shale gas, the calculation model of the free-phase shale gas conductivity is obtained as follows:

$${g}_{free} = \frac{f ( {K}_{n} ) π {r}_{eff}^{4}}{8 μ l} , \qquad ( 12 )$$

where g_{free} free denotes the free-phase shale gas conductivity.

In an embodiment, for the adsorption-phase shale gas in the pore network model, molar flow Jₐ of concentration gradient per unit area of the adsorption-phase shale gas in an adsorption layer is obtained based on Langmuir adsorption isotherm:

$${J}_{a} = {D}_{s} \frac{d {C}_{a}}{d x} , \qquad ( 13 )$$

where Dₛ denotes a surface diffusion coefficient of the adsorption-phase shale gas in unit of m²/s; Cₐ denotes a concentration of the adsorption-phase shale gas in the adsorption layer in unit of mol/m³; x denotes a length of the pore or throat;
a volume flow rate V_{ads} of the adsorption-phase shale gas is obtained by calculation:

$${V}_{ads} = \frac{M}{ρ} {D}_{s} \frac{dC}{dp} π ( {r}^{2} - {r}_{eff}^{2} ) \frac{dp}{dx} , \qquad ( l4 )$$

the concentration of the adsorption-phase shale gas is corrected by a Gibbs excess adsorption capacity, and an equation for calculating the concentration of the adsorption-phase shale gas is as follows:

$${C}_{a} = \frac{τ}{K ( {τ}_{max} - τ )} , \qquad ( 15 )$$

where τ denotes the Gibbs excess adsorption capacity in unit of mmol/g,

$$τ = {τ}_{max} \frac{K {C}_{a}}{1 + K {C}_{a}} ,$$

where τₘₐₓ denotes a maximum adsorption capacity in unit of mmol/g, K denotes a Langmuir adsorption constant,

$$K = \frac{θ}{p ( 1 - θ )} ;$$

A Langmuir dual-site model is used in the pore network model, and a relationship between an absolute adsorption capacity and the maximum adsorption capacity is corrected to obtain:

$${τ}_{a} = {τ}_{max} [ ( 1 - {α}^{′} ) ( \frac{{K}_{1} ( T ) p}{1 + {K}_{1} ( T ) p} ) + α ( \frac{{K}_{2} ( T ) p}{1 + {K}_{2} ( T ) p} ) ] , \qquad ( 16 )$$

where τₐ denotes corrected absolute adsorption capacity; K₁(T) and K₂(T) are both temperature equilibrium constants; α′ denotes a fraction of a second type of sites, 0<α′<1;
a relationship between a volume Vₐ of the adsorption-phase shale gas when combined with a bulk-phase density and a volume Vₘₐₓ of the adsorption-phase shale gas at the maximum adsorption capacity is as follows:

$${V}_{a} = {V}_{max} [ ( 1 - {α}^{′} ) ( \frac{{K}_{1} ( T ) p}{1 + {K}_{1} ( T ) p} ) + {α}^{′} ( \frac{{K}_{2} ( T ) p}{1 + {K}_{2} ( T ) p} ) ] , \qquad ( 17 )$$

when the Langmuir dual-site model is used, an equation for calculating the Gibbs excess adsorption capacity under any temperature and pressure conditions is determined as follows:

$$\begin{matrix}τ ( p , T ) = ( {τ}_{max} - {V}_{max} {ρ}_{g} ) [ ( 1 - {α}^{′} ) ( \frac{{K}_{1} ( T ) p}{1 + {K}_{1} ( T ) p} ) + {α}^{′} ( \frac{{K}_{2} ( T ) p}{1 + {K}_{2} ( T ) p} ) ] \\ = ( {τ}_{max} - {V}_{max} {ρ}_{g} ) f ( p , T )\end{matrix} , \qquad ( 18 )$$

where ρ_{g} denotes a density of the free-phase shale gas; f(p,T) denotes a correction term of Langmuir dual-site number;
an equation for calculating a corrected concentration of the adsorption-phase shale gas is as follows:

$${C}_{a} = \frac{1}{K} \times \frac{f ( p , T ) ( {τ}_{max} - {V}_{max} {ρ}_{g} )}{{τ}_{max} + f ( p , T ) ( {V}_{max} {ρ}_{g} - {τ}_{max} )} , \qquad ( 19 )$$

taking into account high-temperature environment of the deep shale gas and surface coverage degrees of different pores and throats, surface diffusion coefficient Dₛ of the adsorption-phase shale gas is as follows:

$${D}_{s} = {D}_{s 0} \frac{1 - θ + \frac{κ}{2} θ ( 2 - θ ) + H ( 1 - κ ) ( 1 - κ ) \frac{κ}{2} {θ}^{2}}{{( 1 - θ + \frac{κ}{2} θ )}^{2}} , \qquad ( 20 )$$

where Dₛ₀ denotes a surface diffusion coefficient in unit of m²/s when gas coverage degree is 0,

$${D}_{s 0} = 3.1321 \times 1 {0}^{- 7} {T}^{0.5} {e}^{- \frac{Δ {H}^{0.8}}{RT}} ,$$

ΔH denotes isosteric adsorption heat in unit of J/mol when a surface coverage degree is 0; κ denotes a surface diffusion calculation coefficient,

$$κ = \frac{{κ}_{b}}{{κ}_{m}} ,$$

where κ_{b} denotes a rate constant of blockage in surface diffusion, κₘ denotes a rate constant of forward migration in surface diffusion; H(1−κ) denotes a surface diffusion function of the adsorption-phase shale gas,

$$H ( 1 - κ ) = \{ \begin{matrix}0 , & κ \geq 1 \\ 1 , & 0 \leq κ \leq 1\end{matrix} , κ \geq 1$$

means that the adsorption-phase shale gas is prevented from moving and surface diffusion stops, 0≤κ≤1 means that the adsorption-phase shale gas has surface diffusion;
the calculation model of the adsorption-phase shale gas conductivity is determined as follows:

$${g}_{ads} = \frac{1}{l} \frac{M}{ρ} {D}_{S} π ( {r}^{2} - {r}_{eff}^{2} ) \frac{{dC}_{a}}{dp} , \qquad ( 21 )$$

$$where$$

$$\frac{{dC}_{a}}{dp} = \frac{1}{K} \frac{df ( p , T )}{dp} \frac{{τ}_{max} ( {τ}_{max} - {V}_{max} {ρ}_{g} )}{{[ {τ}_{max} - f ( p , T ) ( {τ}_{max} - {V}_{max} {ρ}_{g} ) ]}^{2}} , \qquad ( 22 )$$

$$\frac{df ( p , T )}{dp} = ( 1 - {α}^{′} ) \frac{{K}_{1} ( T )}{{( 1 + {K}_{1} ( T ) p )}^{2}} + {α}^{′} \frac{{K}_{2} ( T )}{{( 1 + {K}_{2} ( T ) p )}^{2}} , \qquad ( 23 )$$

where g_{ads} denotes the adsorption-phase shale gas conductivity.

In an embodiment, in step 3, taking into account adsorption, surface diffusion, Knudsen diffusion, slip and viscous flow of the shale gas in the organic pores and the inorganic pores, an equation for calculating the shale gas conductivity in the organic pores and throats is determined according to the calculation model of the free-phase shale gas conductivity and the calculation model of the adsorption-phase shale gas conductivity:

$${g}_{OM} = {g}_{free} + {g}_{ads} = \frac{f ( {K}_{n} ) π {r}_{eff}^{4}}{8 μ l} + \frac{1}{l} \frac{M}{ρ} {D}_{S} π ( {r}^{2} - {r}_{eff}^{2} ) \frac{{dC}_{a}}{dp} , \qquad ( 24 )$$

where g_{OM} denotes the shale gas conductivity in the organic pores and throats;
by ignoring an adsorption layer in the inorganic pores and throats, and taking into account an influence of Knudsen diffusion, slip and viscous flow, a calculation model of the shale gas conductivity in the inorganic pores and throats without the adsorption layer is as follows:

$${g}_{IM} = {g}_{free} = \frac{f ( Kn ) π {r}^{4}}{8 μ l} , \qquad ( 25 )$$

where g_{IM} denotes the shale gas conductivity in the inorganic pores and throats without the adsorption layer;
because there are four connection modes between pores in the pore network model, a first connection mode is that organic pores are connected with organic pores through organic throats, a second connection mode is that organic pores are connected with inorganic pores through organic throats, a third connection mode is that inorganic pores are connected with organic pores through organic throats, and a fourth connection mode is that inorganic pores are connected with inorganic pores through inorganic throats;
according to pore connection modes in the pore network model, the calculation model of the shale gas conductivity of the pores and throats is established, as shown in equation (26):

$$\frac{{L}_{ij}}{{g}_{ij}} = \{ \begin{matrix}\frac{{L}_{i}}{{g}_{iOM}} + \frac{{L}_{t}}{{g}_{tOM}} + \frac{{L}_{j}}{{g}_{jOM}} , & ( 1 ) \\ \frac{{L}_{i}}{{g}_{iOM}} + \frac{{L}_{t}}{{g}_{tOM}} + \frac{{L}_{j}}{{g}_{jIM}} , & ( 2 ) \\ \frac{{L}_{i}}{{g}_{iIM}} + \frac{{L}_{t}}{{g}_{tOM}} + \frac{{L}_{j}}{{g}_{jOM}} , & ( 3 ) \\ \frac{{L}_{i}}{{g}_{iIM}} + \frac{{L}_{t}}{{g}_{tIM}} + \frac{{L}_{j}}{{g}_{jIM}} , & ( 4 )\end{matrix} , \qquad ( 26 )$$

wherein i and j both denote names of pores; t denotes a name of a throat, which is used to connect a pore i with a pore j; Lᵢⱼ denotes a distance between the pore i and the pore j; gᵢⱼ denotes a shale gas conductivity between the pore i and the pore j; Lᵢ denotes a length of the pore i; Lₜ denotes a length of a throat t; Lⱼ denotes a length of the pore j; g_{iOM} denotes the shale gas conductivity in unit of cm⁴/(MPa·s) when the pore i is an organic pore; g_{tOM} denotes the shale gas conductivity in unit of cm⁴/(MPa·s) when the throat t is an organic throat; g_{jOM} denotes the shale gas conductivity in unit of cm⁴/(MPa·s) when the pore j is an organic pore; g_{iIM} denotes the shale gas conductivity in unit of cm⁴/(MPa·s) when the pore i is an inorganic pore; g_{tIM} denotes the shale gas conductivity in unit of cm⁴/(MPa·s) when the throat t is an inorganic throat; g^{jIM} denotes the shale gas conductivity in unit of cm⁴/(MPa·s) when the pore j is an inorganic pore.

In an embodiment, in step 4, combining the pore network model with the calculation model of the free-phase shale gas conductivity, the calculation model of adsorption-phase shale gas conductivity and the calculation model of shale gas conductivity in pores and throats, the simulation model of the deep shale gas conductivity is established;
a boundary condition of the simulation model of the deep shale gas conductivity is set, the simulation model of the deep shale gas conductivity is used for simulation, temperature and pressure of the simulation model of the deep shale gas conductivity are changed to simulate permeability and diffusivity of the deep shale gas in the simulation model of the deep shale gas conductivity under different temperature and pressure conditions, and the flow law of the deep shale gas is determined.

The present disclosure has the following beneficial effects.

Based on the characteristics of a high temperature and a high pressure in the internal environment of the deep shale gas reservoir, the method takes into full account the influence of the effects of adsorption, slip, Knudsen diffusion, surface diffusion and the like in the process of shale gas flow under the constraint of nano-scale pores, and concurrently takes into account the heterogeneous adsorption phenomenon of deep shale gas on the surfaces of organic pores and throats, and improves the calculation model of the adsorption-phase shale gas conductivity in the deep shale gas reservoir by using a dual-site Langmuir adsorption model. The simulation model of the deep shale gas conductivity is constructed for simulation, which achieves the precise restoration of the flow law of deep shale gas and provides a basis for guiding the exploration and the development of deep shale gas.

### BRIEF DESCRIPTION OF THE DRAWINGS

FIG. 1 is a flow chart of a method for simulating deep shale gas flow based on a dual-site Langmuir adsorption model according to the present disclosure;

FIG. 2 is a Computed Tomography (CT) scan image of a core of a deep shale gas reservoir;

FIG. 3 is an image of a pore phase and a matrix phase;

FIG. 4 is an image showing a three-dimensional (3D) digital core of a deep shale gas reservoir;

FIG. 5 is an image of a pore network model; and

FIG. 6 is a schematic diagram of a connection mode of pores inside a pore network model.

### DETAILED DESCRIPTION OF THE EMBODIMENTS

The detailed description of the present disclosure will be further explained hereinafter with reference to the attached drawings with a deep shale gas reservoir as an example.

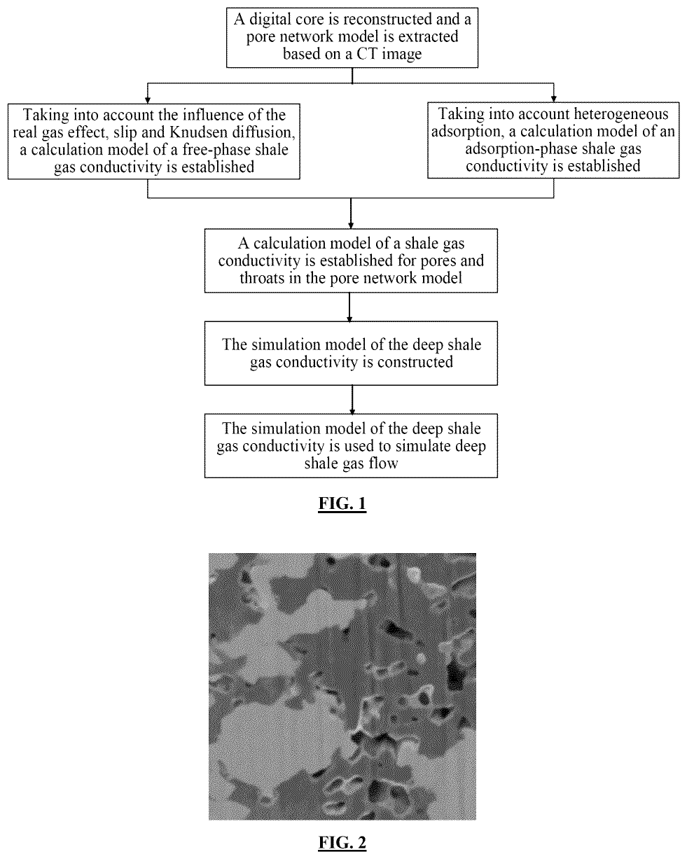

A method for simulating deep shale gas flow based on a dual-site Langmuir adsorption model according to the present disclosure is provided, as shown in FIG. 1, including steps 1-4.

In step 1, a digital core is reconstructed and a pore network model is extracted based on a core scanning image of a deep shale gas reservoir.

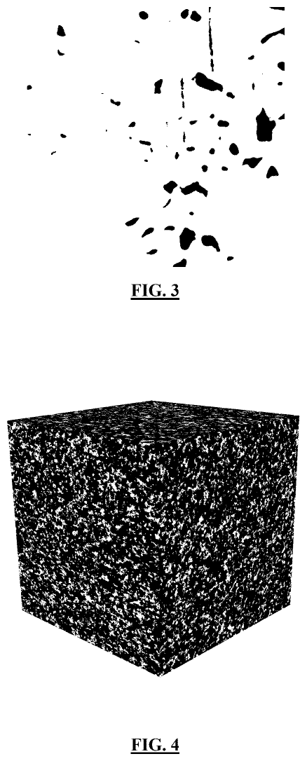

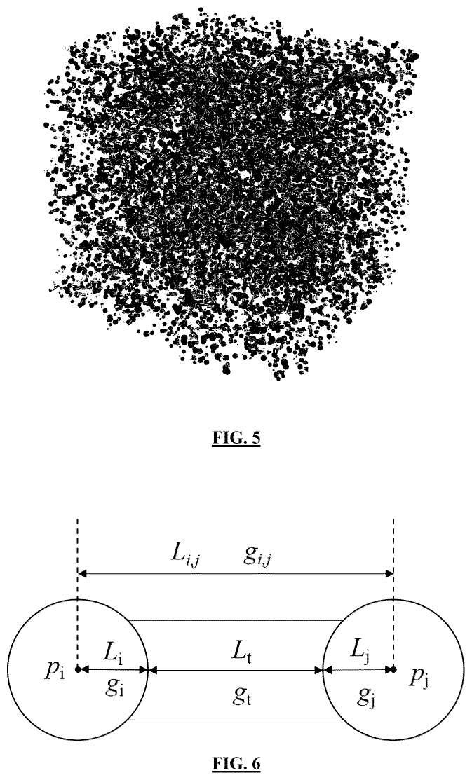

In this embodiment, a CT scanning image of a core of a deep shale gas reservoir is obtained, as shown in FIG. 2. A binary image is obtained by performing binary segmentation on the core scanning image. A pore phase and a matrix phase for subsequent digital core reconstruction in the binary image are identified, as shown in FIG. 3. The digital core is reconstructed by using a Markov Chain Monte Carlo method according to a binary segmentation image, and thus the 3D digital core of the deep shale gas reservoir is obtained, as shown in FIG. 4. The pore network model is extracted by using a maximum sphere method in the existing technology, as shown in FIG. 5.

In step 2, a structural parameter of the pore network model is analyzed, a pore structural property is set, a calculation model of a free-phase shale gas conductivity and a calculation model of an adsorption-phase shale gas conductivity are established, and the free-phase shale gas conductivity and the adsorption-phase shale gas conductivity in the pore network model are determined.

In this embodiment, the structural parameter of the pore network model is analyzed, a pore radius, a throat radius, a coordination number and a shape factor of the pore network model are determined; shale gas, including free-phase shale gas and adsorption-phase shale gas, exists in the pore network model, and adsorption-phase shale gas is single-layer adsorption in the pore network model.

Water-wet inorganic pores and gas-wet organic pores are provided in the pore network model. Adsorption, surface diffusion, Knudsen diffusion, slip and viscous flow are mainly taken into account in organic pores and throats, while Knudsen diffusion, slip and viscous flow are mainly taken into account in inorganic pores and in throats.

Further, for the free-phase shale gas in the pore network model, when the adsorption-phase shale gas exists, an effective migration space of the free-phase shale gas in the organic pores is reduced to obtain:

$$θ = \frac{\frac{p}{Z}}{{p}_{L} + \frac{p}{Z}} \qquad ( 1 )$$

$$h = θ {d}_{m} \qquad ( 2 )$$

$${r}_{eff} = r - {d}_{m} θ \qquad ( 3 )$$

where θ denotes a gas coverage degree on surface of the pore and throat; p denotes a pressure of the pore and throat in unit of MPa; p_{L} denotes a Langmuir pressure in unit of MPa; Z denotes a gas compressibility factor; h denotes a thickness of the adsorption phase in unit of m; dₘ denotes a collision diameter of gas molecules in unit of m; r_{eff} denotes an effective flow radius of the free-phase shale gas in unit of m; r denotes a cross-sectional radius of the pore and throat in unit of m.

Based on the real gas effect, taking into account the influence of the high-temperature and high-pressure environment of the deep shale gas reservoir and the critical temperature and the critical pressure of the nano-scale pore shale gas, a gas property of shale gas changes, so as to influence a gas property of the free-phase shale gas in the pore network model. The critical temperature and the critical pressure of shale gas in the pore network model are determined as follows:

$${T}_{c} = \frac{8}{27 bR} [ a - 2 {σ}^{3} {EN}^{2} \frac{σ}{r} ( 2.6275 - 0.6743 \frac{σ}{r} ) ] , \qquad ( 4 )$$

$${P}_{c} = \frac{8}{27 {b}^{2}} [ a - 2 {σ}^{3} {EN}^{2} \frac{σ}{r} ( 2.6275 - 0.6743 \frac{σ}{r} ) ] , \qquad ( 5 )$$

where T_{c} denotes a critical temperature of the shale gas; P_{c} denotes a critical pressure of the shale gas; R denotes a constant with a value of 8.314; a denotes a van der Waals (vdW) energy parameter in unit of Pa dm⁶/mol²; b denotes a vdW energy parameter in unit of m³/mol; σ denotes a Lennard-Jones size parameter in unit of m; ε denotes a Lennard-Jones energy parameter; N denotes an Avogadro's constant.

The gas property parameter of the free-phase shale gas is calculated according to the critical temperature and the critical pressure of the shale gas as follow:

$${p}_{p r} = \frac{p}{{p}_{c}} , \qquad ( 4 - 1 )$$

$${T}_{p r} = \frac{T}{{T}_{c}} , \qquad ( 5 - 1 )$$

$$ρ = 1. 4935 \times 1 {0}^{- 3} \times \frac{p M}{Z T} , \qquad ( 6 )$$

$$μ = 1 \times 1 {0}^{- 4} \times {K}^{′} {e}^{X {ρ}^{Y}} , \qquad ( 7 )$$

where Z is a compressibility factor of the deep shale gas:

$$Z = 0.702 {e}^{- 2.5 {T}_{p r}} \times {p}_{p r}^{2} - 5.524 {e}^{- 2.5 {T}_{p r}} \times {p}_{p r} + 0.044 {T}_{p r}^{2} - 0.164 {T}_{p r} + 1.15 \qquad ( 8 )$$

where pₚᵣ denotes a relative pressure of the free-phase shale gas; Tₚᵣ denotes a relative temperature of the free-phase shale gas; T denotes a temperature of the pore and throat in unit of K; ρ denotes a density of the shale gas in unit of g/cm³; μ denotes a viscosity of the shale gas in unit of Pa·s; M denotes a molecular mass of the shale gas in unit of g/mol; X, Y and K′ are calculation coefficients of the shale gas viscosity,

$$X = 3.448 + \frac{986.4}{T} + 0.0 \; 1009 M , Y = 2.447 - 0.2 \; 224 X ,$$

$${K}^{′} = \frac{( 9.379 + 0.01607 M ) \times {T}^{1.5}}{( 209.2 + 19.26 M + T )} .$$

Based on a Hagen-Poiseuille equation, an equation for calculating a volume flow rate of the free-phase shale gas is determined as follows:

$$q = f ( {K}_{n} ) \frac{π {r}_{e f f}^{4}}{8 μ} \frac{Δ p}{l} , \qquad ( 9 )$$

$$where$$

$$f ( {K}_{n} ) = ( 1 + α {K}_{n} ) ( 1 + \frac{4 {K}_{n}}{1 - β {K}_{n}} ) , \qquad ( 10 )$$

$$α = \frac{128}{15 {π}^{2}} {tan}^{- 1} [ 4 {K}_{n}^{0.4} ] , \qquad ( 11 )$$

where q denotes the volume flow rate of the free-phase shale gas; f(Kₙ) denotes a term enabling the Poiseuille equation to be applicable to all flow states; Δp denotes a pressure drop in unit of MPa; l denotes a length of the pore or throat in unit of m; α denotes a gas rarefaction coefficient, which is dimensionless; β denotes a slip coefficient, which is dimensionless and is used to describe a gas flow mechanism under a flow pattern corresponding to a Knudsen number; Kₙ denotes the Knudsen number.

Based on the volume flow rate of free-phase shale gas and taking into account a slip effect of the shale gas, the calculation model of the free-phase shale gas conductivity is obtained as follows:

$${g}_{f r e e} = \frac{f ( {K}_{n} ) π {r}_{e f f}^{4}}{8 μ l} , \qquad ( 12 )$$

where g_{free} denotes the free-phase shale gas conductivity.

Furthermore, considering that the adsorption layer of the shale gas is single-layer adsorption, it conforms to the Langmuir adsorption isotherm. For the adsorption-phase shale gas in the pore network model, the molar flow Jₐ of the concentration gradient per unit area of the adsorption-phase shale gas in the adsorption layer is obtained based on the Langmuir adsorption isotherm:

$${J}_{a} = {D}_{s} \frac{d {C}_{a}}{d x} , \qquad ( 13 )$$

where Dₛ denotes a surface diffusion coefficient of the adsorption-phase shale gas in unit of m²/s; Cₐ denotes the concentration of the adsorption-phase shale gas in the adsorption layer in unit of mol/m³; X denotes a length of the pore or throat.

The volume flow rate V_{ads} of the adsorption-phase shale gas is obtained by calculation:

$${V}_{ads} = \frac{M}{ρ} {D}_{s} \frac{{dC}_{a}}{dp} π ( {r}^{2} - {r}_{eff}^{2} ) \frac{dp}{dx} , \qquad ( l4 )$$

Because of the high-pressure environment in the deep shale gas reservoir, the density of adsorption gas is similar to that of bulk-phase free gas under the high-pressure environment, and the analysis shows that the adsorption capacity will decrease after reaching the maximum. Therefore, in order to restore the high-pressure environment of the deep shale gas reservoir more truly, it is necessary to correct the adsorption concentration of the adsorption-phase shale gas.

The concentration of the adsorption-phase shale gas is corrected by a Gibbs excess adsorption capacity, and the equation for calculating the concentration of the adsorption-phase shale gas is as follows:

$${C}_{a} = \frac{τ}{K ( {τ}_{max} - τ )} \qquad ( 15 )$$

where τ denotes a Gibbs excess adsorption capacity in unit of mmol/g,

$$τ = {τ}_{max} \frac{K {C}_{a}}{1 + K {C}_{a}} ,$$

where τₘₐₓ denotes a maximum adsorption capacity in unit of mmol/g, K denotes a Langmuir adsorption constant,

$$K = \frac{θ}{p ( 1 - θ )} .$$

The Langmuir dual-site model is used in the pore network model, and the relationship between an absolute adsorption capacity and a maximum adsorption capacity is corrected to obtain:

$${T}_{a} = {τ}_{max} [ ( 1 - {α}^{′} ) ( \frac{{K}_{1} ( T ) p}{1 + {K}_{1} ( T ) p} ) + α ( \frac{{K}_{2} ( T ) p}{1 + {K}_{2} ( T ) p} ) ] , \qquad ( 16 )$$

where τₐ denotes the corrected absolute adsorption capacity; K₁(T) and K₂(T) are both temperature equilibrium constants; α′ denotes a fraction of a second type of sites, 0<α′<1.

The relationship between a volume Vₐ of adsorption-phase shale gas when combined with a bulk-phase density and a volume Vₘₐₓ of adsorption-phase shale gas at a maximum adsorption capacity is as follows;

$${V}_{a} = {V}_{max} [ ( 1 - {α}^{′} ) ( \frac{{K}_{1} ( T ) p}{1 + {K}_{1} ( T ) p} ) + {α}^{′} ( \frac{{K}_{2} ( T ) p}{1 + {K}_{2} ( T ) p} ) ] , \qquad ( 17 )$$

When the Langmuir dual-site model is used, the equation for calculating the Gibbs excess adsorption capacity under any temperature and pressure conditions is determined as follows:

$$\begin{matrix}τ ( p , T ) = ( {τ}_{max} - {V}_{max} {ρ}_{g} ) [ ( 1 - {α}^{′} ) ( \frac{{K}_{1} ( T ) p}{1 + {K}_{1} ( T ) p} ) + {α}^{′} ( \frac{{K}_{2} ( T ) p}{1 + {K}_{2} ( T ) p} ) ] \\ = ( {τ}_{max} - {V}_{max} {ρ}_{g} ) f ( p , T )\end{matrix} , \qquad ( 18 )$$

where ρ_{g} denotes the density of the free-phase shale gas; f(p,T) denotes a correction term of the Langmuir dual-site number.

The equation for calculating the corrected concentration of the adsorption-phase shale gas is as follows:

$${C}_{a} = \frac{1}{K} \times \frac{f ( p , T ) ( {τ}_{max} - {V}_{max} {ρ}_{g} )}{{τ}_{max} + f ( p , T ) ( {V}_{max} {ρ}_{g} - {τ}_{max} )} , \qquad ( 19 )$$

Taking into account the high-temperature environment of the deep shale gas and the surface coverage degree of different pores and throats, the surface diffusion coefficient Dₛ of the adsorption-phase shale gas is as follows:

$${D}_{s} = {D}_{s 0} \frac{1 - θ + \frac{κ}{2} θ ( 2 - θ ) + H ( 1 - κ ) ( 1 - κ ) \frac{κ}{2} {θ}^{2}}{{( 1 - θ + \frac{κ}{2} θ )}^{2}} , \qquad ( 20 )$$

where Dₛ₀ denotes a surface diffusion coefficient in unit of m²/s when the gas coverage degree is 0,

$${D}_{s 0} = 3.1321 \times {10}^{- 7} {T}^{0.5} {e}^{- \frac{Δ {H}^{0.8}}{RT}} ,$$

ΔH denotes the isosteric adsorption heat in unit of J/mol when the surface coverage degree is 0; κ denotes a surface diffusion calculation coefficient,

$$κ = \frac{{κ}_{b}}{{κ}_{m}} ,$$

where κ_{b} denotes a rate constant of blockage in surface diffusion, κₘ denotes a rate constant of forward migration in surface diffusion; H(1−κ) denotes a surface diffusion function of the adsorption-phase shale gas,

$$H ( 1 - κ ) = \{ \begin{matrix}0 , & κ \geq 1 \\ 1 , & 0 \leq κ \leq 1\end{matrix} ,$$

κ≥1 means that the adsorption-phase shale gas is prevented from moving and the surface diffusion stops, 0≤κ≤1 means that the adsorption-phase shale gas has surface diffusion.

The calculation model of the adsorption-phase shale gas conductivity is determined as follows:

$${g}_{ads} = \frac{1}{l} \frac{M}{ρ} {D}_{S} π ( {r}^{2} - {r}_{eff}^{2} ) \frac{{dC}_{a}}{dp} , \qquad ( 21 )$$

$$where$$

$$\frac{{dC}_{a}}{dp} = \frac{1}{K} \frac{df ( p , T )}{dp} \frac{{τ}_{max} ( {τ}_{max} - {V}_{max} {ρ}_{g} )}{{[ {τ}_{max} - f ( p , T ) ( {τ}_{max} - {V}_{max} {ρ}_{g} ) ]}^{2}} , \qquad ( 22 )$$

$$\frac{df ( p , T )}{dp} = ( 1 - {α}^{′} ) \frac{{K}_{1} ( T )}{{( 1 + {K}_{1} ( T ) p )}^{2}} + {α}^{′} \frac{{K}_{2} ( T )}{{( 1 + {K}_{2} ( T ) p )}^{2}} , \qquad ( 23 )$$

where g_{ads} denotes the adsorption-phase shale gas conductivity.

Step 3, a calculation model of the shale gas conductivity is established for pores and throats in the pore network model according to the calculation model of the free-phase shale gas conductivity and the calculation model of the adsorption-phase shale gas conductivity, and the shale gas conductivity in pores and throats is determined in the pore network model to obtain shale gas conductivities in organic pores, inorganic pores, organic pores and throats and inorganic pores and throats.

In this embodiment, taking into account adsorption, surface diffusion, Knudsen diffusion, slip and viscous flow of the shale gas in organic pores and inorganic pores, the equation for calculating the shale gas conductivity in organic pores and throats is determined according to the calculation model of the free-phase shale gas conductivity and the calculation model of the adsorption-phase shale gas conductivity:

$${g}_{OM} = {g}_{free} + {g}_{ads} = \frac{f ( {K}_{n} ) π {r}_{eff}^{4}}{8 μ l} + \frac{1}{l} \frac{M}{ρ} {D}_{S} π ( {r}^{2} - {r}_{eff}^{2} ) \frac{{dC}_{a}}{dp} , \qquad ( 24 )$$

where g_{OM} denotes the shale gas conductivity in the organic pores and throats.

An adsorption layer in the inorganic pores and throats is ignored, and taking into account the influence of Knudsen diffusion, slip and viscous flow, the calculation model of the shale gas conductivity in inorganic pores and throats without an adsorption layer is as follows:

$${g}_{IM} = {g}_{free} = \frac{f ( Kn ) π {r}^{4}}{8 μ l} , \qquad ( 25 )$$

where g_{IM} denotes the shale gas conductivity in the inorganic pores and throats without an adsorption layer.

Because there are four connection modes between pores in the pore network model, the first connection mode is that organic pores are connected with organic pores through organic throats, the second connection mode is that organic pores are connected with inorganic pores through organic throats, the third connection mode is that inorganic pores are connected with organic pores through organic throats, and the fourth connection mode is that inorganic pores are connected with inorganic pores through inorganic throats.

According to pore connection modes in the pore network model, as shown in FIG. 6, the calculation model of the shale gas conductivity of pores and throats is established, as shown in equation (26):

$$\frac{{L}_{ij}}{{g}_{ij}} = \{ \begin{matrix}\frac{{L}_{i}}{{g}_{iOM}} + \frac{{L}_{t}}{{g}_{tOM}} + \frac{{L}_{j}}{{g}_{jOM}} , & ( 1 ) \\ \frac{{L}_{i}}{{g}_{iOM}} + \frac{{L}_{t}}{{g}_{tOM}} + \frac{{L}_{j}}{{g}_{jIM}} , & ( 2 ) \\ \frac{{L}_{i}}{{g}_{iIM}} + \frac{{L}_{t}}{{g}_{tOM}} + \frac{{L}_{j}}{{g}_{jOM}} , & ( 3 ) \\ \frac{{L}_{i}}{{g}_{iIM}} + \frac{{L}_{t}}{{g}_{tIM}} + \frac{{L}_{j}}{{g}_{jIM}} , & ( 4 )\end{matrix} , \qquad ( 26 )$$

where i and j both denote names of pores; t denotes the name of a throat, which is used to connect a pore i with a pore j; Lᵢⱼ denotes a distance between the pore i and the pore j; gᵢⱼ denotes the shale gas conductivity between the pore i and the pore j; Lᵢ denotes a length of the pore i; Lₜ denotes a length of the throat t; Lⱼ denotes a length of the pore j; g_{iOM} denotes a shale gas conductivity in unit of cm⁴/(MPa·s) when the pore i is an organic pore; g_{tOM} denotes the shale gas conductivity in unit of cm⁴/(MPa·s) when the throat t is an organic throat; g_{jOM} denotes the shale gas conductivity in unit of cm⁴/(MPa·s) when the pore j is an organic pore; g_{iIM} denotes the shale gas conductivity in unit of cm⁴/(MPa·s) when the pore i is an inorganic pore; g_{tIM} denotes the shale gas conductivity in unit of cm⁴/(MPa·s) when the throat t is an inorganic throat; g_{jtM} denotes the shale gas conductivity in unit of cm⁴/(MPa·s) when the pore j is an inorganic pore.

In step 4, based on calculation models of the free-phase shale gas conductivity, the adsorption-phase shale gas conductivity and the shale gas conductivity in pores and throats of the pore network model, a simulation model of a deep shale gas conductivity is established in combination with the pore network model, a boundary condition of the simulation model of the deep shale gas conductivity is set, the simulation model of the deep shale gas conductivity is used for simulation, the temperature and the pressure of the simulation model of the deep shale gas conductivity are changed to simulate the permeability and the diffusivity of the deep shale gas in the simulation model of the deep shale gas conductivity under different temperature and pressure conditions, and the flow law of the deep shale gas is determined.

The method takes into full account the heterogeneous adsorption phenomenon of deep shale gas on the surfaces of organic pores and throats, and improves the calculation of the adsorption-phase shale gas conductivity in the deep shale gas reservoir by using the dual-site Langmuir adsorption model, which achieves the precise restoration of the flow law of shale gas in the deep shale gas reservoir.

Of course, the above description is not a limitation of the present disclosure, and the present disclosure is not limited to the above examples. Changes, modifications, additions or substitutions made by those skilled in the art within the essential scope of the present disclosure should also belong to the scope of protection of the present disclosure.

What is claimed is:

1. A method for simulating deep shale gas flow based on a dual-site Langmuir adsorption model, comprising:
step 1, reconstructing a digital core and extracting a pore network model based on a core scanning image of a deep shale gas reservoir;
step 2, analyzing a structural parameter of the pore network model, setting a pore structural property, establishing a calculation model of a free-phase shale gas conductivity and a calculation model of an adsorption-phase shale gas conductivity, and determining the free-phase shale gas conductivity and the adsorption-phase shale gas conductivity in the pore network model;
step 3, establishing a calculation model of a shale gas conductivity for pores and throats in the pore network model according to the calculation model of the free-phase shale gas conductivity and the calculation model of the adsorption-phase shale gas conductivity, and determining shale gas conductivity for the pores and throats in the pore network model to obtain shale gas conductivities in organic pores, inorganic pores, organic pores and throats and inorganic pores and throats;
step 4, based on the calculation model of the free-phase shale gas conductivity, the calculation model of the adsorption-phase shale gas conductivity and the calculation model of the shale gas conductivity for the pores and throats in the pore network model, establishing a simulation model of a deep shale gas conductivity in combination with the pore network model, and determining a flow law of deep shale gas under different sensitivity parameter conditions by using the simulation model of the deep shale gas conductivity for simulation.

2. The method for simulating the deep shale gas flow based on the dual-site Langmuir adsorption model according to claim 1, wherein in step 1, the core scanning image of the deep shale gas reservoir is obtained, a binary image is obtained by performing binary segmentation on the core scanning image, after a pore phase and a matrix phase in the binary image are identified, the digital core is reconstructed by using a Markov Chain Monte Carlo method according to a binary segmented image, and the pore network model is extracted by using a maximum sphere method.

3. The method for simulating the deep shale gas flow based on the dual-site Langmuir adsorption model according to claim 2, wherein the core scanning image is a Computed Tomography (CT) scanning image or a Scanning Electron Microscope (SEM) scanning image of the core.

4. The method for simulating the deep shale gas flow based on the dual-site Langmuir adsorption model according to claim 1, wherein in step 2, analyzing structural parameters of the pore network model comprises: determining a pore radius, a throat radius, a coordination number and a shape factor of the pore network model, assigning water-wet inorganic pores and gas-wet organic pores in the pore network model, wherein shale gas comprising free-phase shale gas and adsorption-phase shale gas is provided in the pore network model, and the adsorption-phase shale gas is single-layer adsorption in the pore network model.

5. The method for simulating the deep shale gas flow based on the dual-site Langmuir adsorption model according to claim 4, wherein for the free-phase shale gas in the pore network model, when the adsorption-phase shale gas exists, an effective migration space of the free-phase shale gas in the organic pores is reduced to obtain:
$$θ = \frac{\frac{p}{Z}}{{p}_{L} + \frac{p}{Z}} , \qquad ( 1 )$$
$$h = θ {d}_{m} , \qquad ( 2 )$$
$${r}_{eff} = r - {d}_{m} θ , \qquad ( 3 )$$
where θ denotes a gas coverage degree on surface of a pore and throat; p denotes a pressure of the pore and throat in unit of MPa; p_{L} denotes a Langmuir pressure in unit of MPa; Z denotes a gas compressibility factor; h denotes a thickness of an adsorption phase in unit of m; dₘ denotes a collision diameter of gas molecules in unit of m; r_{eff} denotes an effective flow radius of the free-phase shale gas in unit of m; r denotes a cross-sectional radius of the pore and throat in unit of m;
taking into account an influence of high-temperature and high-pressure environment on a critical temperature and a critical pressure of the shale gas in the pore network model, a gas property of the free-phase shale gas in the pore network model changes;
the critical temperature and the critical pressure of the shale gas in the pore network model are calculated as follows:
$${T}_{c} = \frac{8}{27 bR} [ a - 2 {σ}^{3} ε {N}^{2} \frac{σ}{r} ( 2.6275 - 0.6743 \frac{σ}{r} ) ] , \qquad ( 4 )$$
$${P}_{c} = \frac{8}{27 {b}^{2}} [ a - 2 {σ}^{3} ε {N}^{2} \frac{σ}{r} ( 2.6275 - 0.6743 \frac{σ}{r} ) ] , \qquad ( 5 )$$
where T_{c} denotes the critical temperature of the shale gas; P_{c} denotes the critical pressure of the shale gas; R denotes a constant with a value of 8.314; @ denotes a van der Waals (vdW) energy parameter in unit of Pa dm⁶/mol²; b denotes a vdW energy parameter in unit of m³/mol; σ denotes a Lennard-Jones size parameter in unit of m; ε denotes a Lennard-Jones energy parameter; N denotes an Avogadro's constant;
gas property parameters of the free-phase shale gas are calculated according to the critical temperature and the critical pressure of the shale gas to obtain:
$${p}_{pr} = \frac{p}{{p}_{c}} , \qquad ( 4 - 1 )$$
$${T}_{pr} = \frac{T}{{T}_{c}} , \qquad ( 5 - 1 )$$
$$ρ = 1.4935 \times {10}^{- 3} \times \frac{pM}{ZT} , \qquad ( 6 )$$
$$μ = 1 \times {10}^{- 4} \times {K}^{′} {e}^{X {ρ}^{Y}} , \qquad ( 7 )$$
$$where$$
$$Z = 0.702 {e}^{- 2.5 {T}_{pr}} \times {p}_{pr}^{2} - 5.524 {e}^{- 2.5 {T}_{pr}} \times {p}_{pr} + 0.044 {T}_{pr}^{2} - 0.164 {T}_{pr} + 1.15 , \qquad ( 8 )$$
where pₚᵣ denotes a relative pressure of the free-phase shale gas; Tₚᵣ denotes a relative temperature of the free-phase shale gas; T denotes a temperature of the pore and throat in unit of K; ρ denotes a density of the shale gas in unit of g/cm³; μ denotes a viscosity of the shale gas in unit of Pa·s; M denotes a molecular mass of the shale gas in unit of g/mol; X, Y and K′ are calculation coefficients of shale gas viscosity,
$$X = 3.448 + \frac{986.4}{T} + 0.01009 M ,$$
$$Y = 2.447 - 0.2224 X , {K}^{′} = \frac{( 9.379 + 0.01607 M ) \times {T}^{1.5}}{( 209.2 + 19.26 M + T )} ;$$
based on a Hagen-Poiseuille equation, an equation for calculating a volume flow rate of the free-phase shale gas is determined as follows:
$$q = f ( {K}_{n} ) \frac{π {r}_{eff}^{4}}{8 μ} \frac{Δ p}{l} , \qquad ( 9 )$$
$$where$$
$$f ( {K}_{n} ) = ( 1 + α {K}_{n} ) ( 1 + \frac{4 {K}_{n}}{1 - β {K}_{n}} ) , \qquad ( 10 )$$
$$α = \frac{128}{15 {π}^{2}} {tan}^{- 1} [ 4 {K}_{n}^{0.4} ] , \qquad ( 11 )$$
where q denotes the volume flow rate of the free-phase shale gas; f(Kₙ) denotes a term enabling the Poiseuille equation to be applicable to all flow states; ΔP denotes a pressure drop in unit of MPa; l denotes a length of a pore or throat in unit of m; α denotes a gas rarefaction coefficient, which is dimensionless; B denotes a slip coefficient, which is dimensionless; Kₙ denotes a Knudsen number;
based on the volume flow rate of the free-phase shale gas and taking into account a slip effect of the shale gas, the calculation model of the free-phase shale gas conductivity is obtained as follows:
$${g}_{free} = \frac{f ( {K}_{n} ) π {r}_{eff}^{4}}{8 μ l} , \qquad ( 12 )$$
where g_{free} denotes the free-phase shale gas conductivity.

6. The method for simulating the deep shale gas flow based on the dual-site Langmuir adsorption model according to claim 5, wherein for the adsorption-phase shale gas in the pore network model, molar flow Jₐ of concentration gradient per unit area of the adsorption-phase shale gas in an adsorption layer is obtained based on Langmuir adsorption isotherm:
$${J}_{a} = {D}_{s} \frac{{dC}_{a}}{dx} , \qquad ( 13 )$$
where Dₛ denotes a surface diffusion coefficient of the adsorption-phase shale gas in unit of m²/s; Cₐ denotes a concentration of the adsorption-phase shale gas in the adsorption layer in unit of mol/m³; X denotes a length of the pore or throat;
a volume flow rate V_{ads} of the adsorption-phase shale gas is obtained by calculation:
$${V}_{ads} = \frac{M}{ρ} {D}_{s} \frac{{dC}_{a}}{dp} π ( {r}^{2} - {r}_{eff}^{2} ) \frac{dp}{dx} , \qquad ( 14 )$$
the concentration of the adsorption-phase shale gas is corrected by a Gibbs excess adsorption capacity, and an equation for calculating the concentration of the adsorption-phase shale gas is as follows:
$${C}_{a} = \frac{τ}{K ( {τ}_{max} - τ )} , \qquad ( 15 )$$
where τ denotes the Gibbs excess adsorption capacity in unit of mmol/g,
$$τ = {τ}_{max} \frac{{KC}_{a}}{1 + {KC}_{a}} ,$$
where τₘₐₓ denotes a maximum adsorption capacity in unit of mmol/g, K denotes a Langmuir adsorption constant,
$$K = \frac{θ}{p ( 1 - θ )} ;$$
a Langmuir dual-site model is used in the pore network model, and a relationship between an absolute adsorption capacity and the maximum adsorption capacity is corrected to obtain:
$${τ}_{a} = {τ}_{max} [ ( 1 - {α}^{′} ) ( \frac{{K}_{1} ( T ) p}{1 + {K}_{1} ( T ) p} ) + α ( \frac{{K}_{2} ( T ) p}{1 + {K}_{2} ( T ) p} ) ] , \qquad ( 16 )$$
where τₐ denotes corrected absolute adsorption capacity; K₁(T) and K₂(T) are both temperature equilibrium constants; α′ denotes a fraction of a second type of sites, 0<α′<1;
a relationship between a volume Vₐ of the adsorption-phase shale gas when combined with a bulk-phase density and a volume Vₘₐₓ of the adsorption-phase shale gas at the maximum adsorption capacity is as follows:
$${V}_{a} = {V}_{max} [ ( 1 - {α}^{′} ) ( \frac{{K}_{1} ( T ) p}{1 + {K}_{1} ( T ) p} ) + {α}^{′} ( \frac{{K}_{2} ( T ) p}{1 + {K}_{2} ( T ) p} ) ] , \qquad ( 17 )$$
when the Langmuir dual-site model is used, an equation for calculating the Gibbs excess adsorption capacity under any temperature and pressure conditions is determined as follows:
$$\begin{matrix}τ ( p , T ) = ( {τ}_{max} - {V}_{max} {ρ}_{g} ) [ ( 1 - {α}^{′} ) ( \frac{{K}_{1} ( T ) p}{1 + {K}_{1} ( T ) p} ) + {α}^{′} ( \frac{{K}_{2} ( T ) p}{1 + {K}_{2} ( T ) p} ) ] \\ = ( {τ}_{max} - {V}_{max} {ρ}_{g} ) f ( p , T )\end{matrix} , \qquad ( 18 )$$
where ρ_{g} denotes a density of the free-phase shale gas; f(p,T) denotes a correction term of Langmuir dual-site number;
an equation for calculating a corrected concentration of the adsorption-phase shale gas is as follows:
$${C}_{a} = \frac{1}{K} \times \frac{f ( p , T ) ( {τ}_{max} - {V}_{max} {ρ}_{g} )}{{τ}_{max} + f ( p , T ) ( {V}_{max} {ρ}_{g} - {τ}_{max} )} , \qquad ( 19 )$$
taking into account high-temperature environment of the deep shale gas and surface coverage degrees of different pores and throats, surface diffusion coefficient Dₛ of the adsorption-phase shale gas is as follows:
$${D}_{s} = {D}_{s 0} \frac{1 - θ + \frac{κ}{2} θ ( 2 - θ ) + H ( 1 - κ ) ( 1 - κ ) \frac{κ}{2} {θ}^{2}}{{( 1 - θ + \frac{κ}{2} θ )}^{2}} , \qquad ( 20 )$$
where Dₛ₀ denotes a surface diffusion coefficient in unit of m²/s when gas coverage degree is 0,
$${D}_{s 0} = 3.1321 \times 1 {0}^{- 7} {T}^{0.5} {e}^{- \frac{Δ {H}^{0.8}}{RT}} ,$$
ΔH denotes isosteric adsorption heat in unit of J/mol when a surface coverage degree is 0; κ denotes a surface diffusion calculation coefficient,
$$κ = \frac{{κ}_{b}}{{κ}_{m}} ,$$
where κ_{b} denotes a rate constant of blockage in surface diffusion, κₘ denotes a rate constant of forward migration in surface diffusion; H(1−κ) denotes a surface diffusion function of the adsorption-phase shale gas,
$$H ( 1 - κ ) = \{ \begin{matrix}0 , κ \geq 1 \\ 1 , 0 \leq κ \leq 1\end{matrix} ,$$
κ≥1 means that the adsorption-phase shale gas is prevented from moving and surface diffusion stops, 0≤κ≤1 means that the adsorption-phase shale gas has surface diffusion;
the calculation model of the adsorption-phase shale gas conductivity is determined as follows:
$${g}_{ads} = \frac{1}{l} \frac{M}{ρ} {D}_{s} π ( {r}^{2} - {r}_{eff}^{2} ) \frac{{dC}_{a}}{dp} , \qquad ( 21 )$$
$$where$$
$$\frac{{dC}_{a}}{dp} = \frac{1}{K} \frac{df ( p , T )}{dp} \frac{{τ}_{max} ( {τ}_{max} - {V}_{max} {ρ}_{g} )}{{[ {τ}_{max} - f ( p , T ) ( {τ}_{max} - {V}_{max} {ρ}_{g} ) ]}^{2}} , \qquad ( 22 )$$
$$\frac{df ( p , T )}{dp} = ( 1 - {α}^{′} ) \frac{{K}_{1} ( T )}{{( 1 + {K}_{1} ( T ) p )}^{2}} + {α}^{′} \frac{{K}_{2} ( T )}{{( 1 + {K}_{2} ( T ) p )}^{2}} , \qquad ( 23 )$$
where δ_{ads} denotes the adsorption-phase shale gas conductivity.

7. The method for simulating the deep shale gas flow based on the dual-site Langmuir adsorption model according to claim 6, wherein in step 3, taking into account adsorption, surface diffusion, Knudsen diffusion, slip and viscous flow of the shale gas in the organic pores and the inorganic pores, an equation for calculating the shale gas conductivity in the organic pores and throats is determined according to the calculation model of the free-phase shale gas conductivity and the calculation model of the adsorption-phase shale gas conductivity:
$${g}_{OM} = {g}_{free} + {g}_{ads} = \frac{f ( {K}_{n} ) π {r}_{eff}^{4}}{8 μ l} + \frac{1}{l} \frac{M}{ρ} {D}_{S} π ( {r}^{2} - {r}_{eff}^{2} ) \frac{{dC}_{a}}{dp} , \qquad ( 24 )$$
where g_{OM} denotes the shale gas conductivity in the organic pores and throats;
by ignoring an adsorption layer in the inorganic pores and throats, and taking into account an influence of Knudsen diffusion, slip and viscous flow, a calculation model of the shale gas conductivity in the inorganic pores and throats without the adsorption layer is as follows:
$${g}_{IM} = {g}_{free} = \frac{f ( Kn ) π {r}^{4}}{8 μ l} , \qquad ( 25 )$$
where g_{IM} denotes the shale gas conductivity in the inorganic pores and throats without the adsorption layer;
because there are four connection modes between pores in the pore network model, a first connection mode is that organic pores are connected with organic pores through organic throats, a second connection mode is that organic pores are connected with inorganic pores through organic throats, a third connection mode is that inorganic pores are connected with organic pores through organic throats, and a fourth connection mode is that inorganic pores are connected with inorganic pores through inorganic throats;
according to pore connection modes in the pore network model, the calculation model of the shale gas conductivity of pores and throats is established, as shown in equation (26):
$$\frac{{L}_{ij}}{{g}_{ij}} = \{ \begin{matrix}\frac{{L}_{i}}{{g}_{iOM}} + \frac{{L}_{t}}{{g}_{tOM}} + \frac{{L}_{j}}{{g}_{jOM}} , ( 1 ) \\ \frac{{L}_{i}}{{g}_{iOM}} + \frac{{L}_{t}}{{g}_{tOM}} + \frac{{L}_{j}}{{g}_{jIM}} , ( 2 ) \\ \frac{{L}_{i}}{{g}_{iIM}} + \frac{{L}_{t}}{{g}_{tOM}} + \frac{{L}_{j}}{{g}_{jOM}} , ( 3 ) \\ \frac{{L}_{i}}{{g}_{iIM}} + \frac{{L}_{t}}{{g}_{tIM}} + \frac{{L}_{j}}{{g}_{jIM}} , ( 4 )\end{matrix} , \qquad ( 26 )$$
where i and j both denote names of pores; t denotes a name of a throat, which is used to connect a pore i with a pore j; Lᵢⱼ denotes a distance between the pore i and the pore j; gij denotes a shale gas conductivity between the pore i and the pore j; Lᵢ denotes a length of the pore i; Lᵢ denotes a length of a throat t; Lⱼ denotes a length of the pore j; g_{iOM} denotes the shale gas conductivity in unit of cm⁴/(MPa·s) when the pore i is an organic pore; g_{tOM} denotes the shale gas conductivity in unit of cm⁴/(MPa·s) when the throat t is an organic throat; g_{jOM} denotes the shale gas conductivity in unit of cm⁴/(MPa·s) when the pore j is an organic pore; g_{iIM} denotes the shale gas conductivity in unit of cm⁴/(MPa·s) when the pore i is an inorganic pore; g_{tIM} denotes the shale gas conductivity in unit of cm⁴/(MPa·s) when the throat t is an inorganic throat; g_{jIM} denotes the shale gas conductivity in unit of cm⁴/(MPa·s) when the pore j is an inorganic pore.

8. The method for simulating the deep shale gas flow based on the dual-site Langmuir adsorption model according to claim 1, wherein in step 4, combining the pore network model with the calculation model of the free-phase shale gas conductivity, the calculation model of adsorption-phase shale gas conductivity and the calculation model of shale gas conductivity in pores and throats, the simulation model of the deep shale gas conductivity is established;
a boundary condition of the simulation model of the deep shale gas conductivity is set, the simulation model of the deep shale gas conductivity is used for simulation, temperature and pressure of the simulation model of the deep shale gas conductivity are changed to simulate permeability and diffusivity of the deep shale gas in the simulation model of the deep shale gas conductivity under different temperature and pressure conditions, and the flow law of the deep shale gas is determined.
